(19) United States
(12) Patent Application Publication
(10) Pub. No.: US 2025/0332723 A1
(43) Pub. Date: Oct. 30, 2025

(54) METHOD FOR CONTROLLING ROBOT BASED ON WEB BROWSER AND ROBOT USING SAME

(71) Applicant: NAVER CORPORATION, Seongnam-si (KR)

(72) Inventors: Kyung-Sik PARK, Seongnam-si (KR); Dong Jun KIM, Seongnam-si (KR); Seong Won LEE, Seongnam-si (KR); Hyungwook LEE, Seongnam-si (KR); Chang Wan HONG, Seongnam-si (KR); Jaejung BYUN, Seongnam-si (KR); Seungin CHA, Seongnam-si (KR); Woo-Young CHOI, Seongnam-si (KR)

(21) Appl. No.: 19/261,503

(22) Filed: Jul. 7, 2025

Related U.S. Application Data
(63) Continuation of application No. PCT/KR2024/000331, filed on Jan. 8, 2024.

(30) Foreign Application Priority Data
Jan. 6, 2023 (KR) 10-2023-0002049

(51) Int. Cl. B25J 9/16; H04L 67/025

(52) U.S. Cl. CPC B25J 9/1658; H04L 67/025

(57) ABSTRACT

A web browser-based robot control method includes installing, on a web browser of a robot, a robot web application for controlling the robot; and controlling the robot as the robot web application communicates with hardware of the robot through the web browser.

### CROSS-REFERENCE TO RELATED APPLICATIONS

This is a continuation application of International Application No. PCT/KR2024/000331, filed Jan. 8, 2024, which claims the benefit of Korean Patent Application No. 10-2023-0002049, filed Jan. 6, 2023.

### BACKGROUND OF THE INVENTION

### Field of the Invention

The present disclosure relates to a robot control method capable of performing control over a robot based on a web browser.

### Description of Related Art

Customer services using robots are provided in various places such as airports, hospitals, shopping malls, hotels, and restaurants. Airport robots guide passengers to boarding gates and move heavy luggage. Hospital robots guide patients to examination rooms and help make appointments. Concierge robots guide guests to their assigned rooms and provide room service. Serving robots serve food ordered by customers without letting it get cold.

However, each robot is designed to provide a dedicated service, so the robot has problems such as a lack of expandability and flexibility to be easily changed to provide other services.

### BRIEF SUMMARY OF THE INVENTION

The present invention is directed to a web browser-based robot control method capable of performing control over a robot based on a web browser, and a robot using the same.

The present invention is directed to a web browser-based robot control method capable of implementing the primary functions of the robot through a robot web application that operates on a web browser, and a robot using the same.

A robot control method based on a web browser according to an embodiment of the present invention may include installing a robot web application for controlling a robot in a web browser of the robot; and controlling the robot by having the robot web application communicate with hardware of the robot through the web browser.

A robot according to an embodiment of the present invention may include a processor, and the processor may be configured to install a robot web application for controlling the robot in a web browser of the robot; and control the robot by having the robot web application communicate with hardware of the robot through the web browser.

In addition, the above-mentioned solutions to the problems do not enumerate all the features of the present disclosure. The various features of the present invention and the advantages and effects thereof will be understood in more detail with reference to the embodiments below.

According to the web browser-based robot control method according to an embodiment of the present invention and the robot using the same, communication can be performed with the hardware of the robot by defining a robot control API in the web browser. Therefore, it is possible to control the operation of the robot using the robot web application installed in the web browser.

According to the web browser-based robot control method according to an embodiment of the present disclosure and the robot using the same, since the robot provides a service according to the robot web application installed in the web browser, it is possible to easily change the service provided by the robot to other services simply by replacing the robot web application.

However, the effects obtainable from the web browser-based robot control method according to the embodiments of the present disclosure and the robot using the same are not limited to those mentioned above, and other effects that are not mentioned will be clearly understood by those skilled in the art to which the present disclosure pertains from the description below.

### BRIEF DESCRIPTION OF THE DRAWINGS

FIG. 1 is a block diagram illustrating a robot system supporting web browser-based robot control according to an embodiment of the present invention.

FIGS. 2A, 2B, and 3 are diagrams illustrating the operation of a robot according to an embodiment of the present invention.

FIG. 4 is a block diagram illustrating a robot according to an embodiment of the present invention.

FIG. 5 is a flowchart illustrating a web browser-based robot control method according to an embodiment of the present invention.

### DETAILED DESCRIPTION OF THE INVENTION

Hereinafter, the embodiments disclosed in this specification will be described in detail with reference to the attached drawings. Regardless of the reference numerals, identical or similar elements will be assigned the same reference numerals, and redundant descriptions thereof will be omitted.

In addition, in describing the embodiments disclosed in this specification, a detailed description of a related known technology, which may obscure the subject matter of the embodiments disclosed in this specification, will be omitted. In addition, the attached drawings are only intended to facilitate easy understanding of the embodiments disclosed in this specification, and the technical ideas disclosed in this specification are not limited to the attached drawings, and should be understood to include all modifications, equivalents, or substitutes included in the concept and scope of the invention.

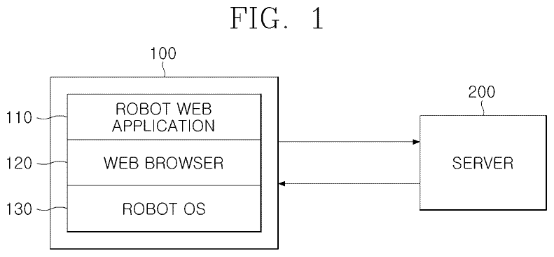

FIG. 1 is a drawing illustrating a robot system supporting web browser-based robot control according to an embodiment of the present invention.

Referring to FIG. 1, a robot system according to an embodiment of the present disclosure may include a robot 100 and a server 200.

The robot 100 may be a device that performs various services while moving within a target area. Here, the target area may be an indoor space such as a building, and the robot 100 may move within the target area in an autonomous manner, but positioning of the robot 100 and control of its movement may be performed by the server 200. That is, the robot 100 may perform operations such as movement through communication with the server 200. Depending on the embodiment, some of the control may be performed by the robot 100 and the server 200 to perform overall control.

The robot 100 may include a camera, and may capture surrounding images corresponding to the movement of the robot 100 using the camera. The robot 100 may transmit surrounding images or the like to the server 200, and the server 200, based on the received surrounding images, may perform visual localization or the like for the robot 100.

Depending on the embodiment, the robot 100 may further include various sensors such as an IMU (Inertial Measurement Unit) sensor, a wheel encoder sensor, a lidar sensor, and the like, in addition to the camera, and the server 100 may also perform additional localization for the robot 100 in a different way from the visual localization.

The server 200 may communicate with the robots 100 located within the target area through a network and control various operations including the movement of the robots 100. Here, the communication method between the server 200 and the robot 100 is not limited, and may include not only a communication method utilizing a communication network (e.g., a mobile communication network, the wired Internet, the wireless Internet, a broadcasting network, a satellite network, etc.) capable of being included in the network, but also short-range wireless communication between devices. For example, the network may include any one or more of networks such as a PAN (personal area network), a LAN (local area network), a CAN (campus area network), a MAN (metropolitan area network), a WAN (wide area network), a BBN (broadband network), and the Internet. In addition, the network may include any one or more of network topologies including a bus network, a star network, a ring network, a mesh network, a star-bus network, and a tree or hierarchical network, but is not limited thereto.

The server 200 may be implemented as a computer device or a plurality of computer devices that communicate with the robot 100 through a network to provide commands, codes, files, content, services, and the like. Depending on the embodiment, it is also possible to implement the server in the form of a cloud server.

The robot 100 may have a robot OS 130 for controlling the operation of hardware included in the robot 100 and a web browser 120 for communication with the server 200, which are installed therein. Here, a robot web application 110 may be installed in the web browser 120. That is, the robot web application 110 is a set of software for controlling the operation of the robot 100, and may be operated on the web browser 110. According to an embodiment of the present invention, the robot web application 110 may communicate with the hardware of the robot 100 through the web browser 120, and through this, the robot web application 110 may control the operation of the robot 100.

According to an embodiment, the server 200 may distribute the robot web application 110 to each robot 100, and in addition, the server 200 may provide management such as addition, deletion, change, and update for the robot web application 110. Here, the robot 100 may provide different services depending on the type of the robot web application distributed by the server 200. For example, in the case where the robot web application 110 distributed by the server 200 is related to a route guidance service, the robot 100 may provide a service such as escorting a user to the store that the user wishes to visit in a shopping mall or the like.

However, in the case where there are many robots 100 performing route guidance, a robot web application 110 providing a product delivery service may be distributed to some robots 100, replacing the previously distributed robot web application 110, for efficient use. In this case, the robot 100 in which the robot web application 110 corresponding to the product delivery service is installed no longer provides a user guidance service, but may perform a product delivery service for delivering products to respective input locations. That is, it is possible to easily cause the robot 100 to provide different services simply by changing the robot web application 110 installed in the web browser 120 of the robot 100.

Here, the web browser 120 may be implemented using the Chromium Operating System, the Chrome Operating System, the Whale Operating System, etc., and the web browser 120 may be a dedicated web browser customized such that the robot web application 110 is able to control the hardware of the robot 100. However, it is not limited thereto, and the web browser 120 may also be implemented using various Linux-based OSs such as Ubuntu, Debian, and the like.

Specifically, the web browser 120 may define a robot control API (Application Programming Interface) for controlling the hardware of the robot 100 and perform communication with the hardware of the robot using the robot control API. That is, in the case of a general web browser, the range of access to the hardware of the robot 100 is limited, so a dedicated web browser that defines additional robot control APIs may be used to enable access to the hardware of the robot 100.

The robot control API may include motor control of the robot 100 such as motor speed, position, and torque, setting of a movement path plan such as waypoints, setting of a goal point, acquisition of various sensor values, voice commands, etc., and may be configured in various ways from low-level motor control to high-level abstract commands. However, it is not limited thereto, and various types of robot control APIs may be further included depending on the embodiment.

As described above, when utilizing a dedicated web browser, since the API call for hardware control of the robot 100 may be directly connected to the hardware of the robot, it may be advantageous in terms of real-time performance, and may be implemented in a lower-level programming browser. That is, since the dedicated web browser may directly communicate with the hardware of the robot using the robot control API, it is possible to obtain advantageous effects such as avoiding multiple relays when transmitting control commands, input from the robot web application through the web browser, to the hardware of the robot. However, in the case where the dedicated web browser described above is standardized, the robot control APIs are installed and used in a general web browser, so it is possible to control the operation of the robot using a general web browser.

Depending on the embodiment, it is also possible to further include a proxy application in the general web browser 120 so that the proxy application performs communication with the hardware of the robot. That is, connection with the proxy application may be performed using a web socket or the like, and additional protocols for the proxy application to communicate with the hardware of the robot may be further defined, thereby performing connection.

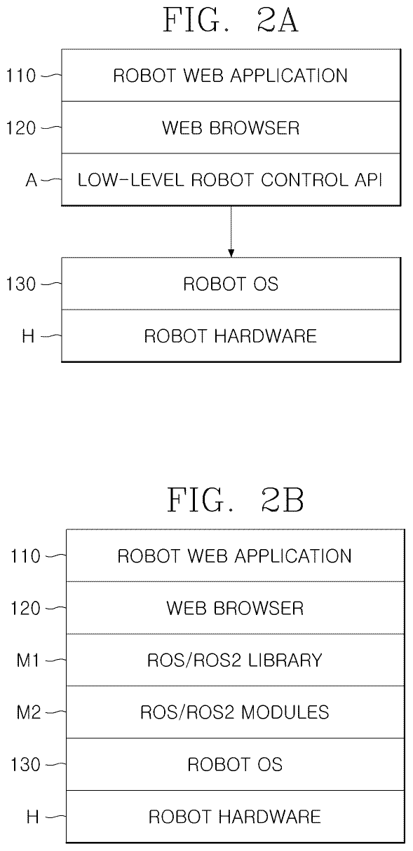

Referring to FIGS. 2A and 2B, the robot 100 according to an embodiment of the present invention may communicate directly with the robot OS 130 through the web browser 120 or communicate with the robot OS 130 through middleware M1 and M2.

That is, as illustrated in FIG. 2A, the web browser 120 may perform direct control of the hardware H of the robot 100 using a low-level robot control API A.

However, depending on the embodiment, as illustrated in FIG. 2B, it is also possible to perform communication with the hardware H of the robot 100 through the robot middleware M1 and M2 such as ROS or ROS2. In this case, the web browser 120 may convert a control command received from the robot web application 110 into a middleware message for communicating with ROS or ROS2. Afterwards, the middleware M1 and M2 may convert the received middleware message back into a message capable of being processed by the robot OS 130, thereby performing control. Here, the robot control API A may be defined so that the robot web application 110 may directly poll or register a callback for the sensor values received from the sensors included in the robot 100.

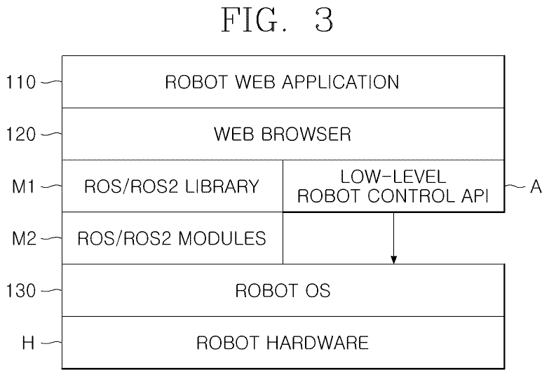

In addition, as illustrated in FIG. 3, depending on the type of control command, the web browser 120 is able to directly communicate with the hardware H of the robot using the robot control API A or to communicate with hardware H of the robot using the middleware M1 and M2.

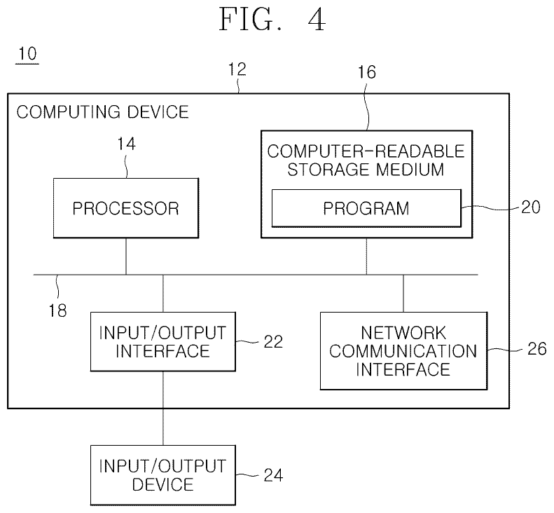

FIG. 4 is a block diagram illustrating a computing environment 10 suitable for use in exemplary embodiments. In the illustrated embodiment, the respective components may have different functions and capabilities other than those described below, and additional components may be further included in addition to those described below.

The illustrated computing environment 10 includes a computing device 12. In an embodiment, the computing device 12 may be a robot device (e.g., the robot 100) controlled based on a web browser.

The computing device 12 includes at least one processor 14, a computer-readable storage medium 16, and a communication bus 18. The processor 14 may cause the computing device 12 to operate according to the exemplary embodiments mentioned above. For example, the processor 14 may execute one or more programs stored in the computer-readable storage medium 16. The one or more programs may include one or more computer-executable instructions, and the computer-executable instructions may be configured to cause, when executed by the processor 14, the computing device 12 to perform operations according to the exemplary embodiments.

The computer-readable storage medium 16 is configured to store computer-executable instructions, program code, program data, and/or other suitable forms of information. The program 20 stored on the computer-readable storage medium 16 includes a set of instructions executable by the processor 14. In an embodiment, the computer-readable storage medium 16 may be memory (volatile memory, such as random-access memory, nonvolatile memory, or a suitable combination thereof), one or more magnetic disk storage devices, optical disk storage devices, flash memory devices, another type of storage medium capable of being accessed by the computing device 12 and storing desired information, or a suitable combination thereof.

The communication bus 18 interconnects various components of the computing device 12, including the processor 14 and the computer-readable storage medium 16.

The computing device 12 may also include one or more input/output interfaces 22 that provide interfaces for one or more input/output devices 24, and one or more network communication interfaces 26. The input/output interfaces 22 and the network communication interfaces 26 are connected to the communication bus 18. The input/output device 24 may be connected to other components of the computing device 12 via the input/output interfaces 22. For example, the input/output devices 24 may include input devices such as a pointing device (mouse, trackpad, etc.), a keyboard, a touch input device (touchpad, touchscreen, etc.), a voice or sound input device, various types of sensor devices, and/or photographing devices, and/or output devices such as a display device, a printer, a speaker, and/or a network card. The exemplary input/output device 24 may be included inside the computing device 12 as a component that constitutes the computing device 12, or may be configured as a separate device distinct from the computing device 12 and connected to the computing device 12.

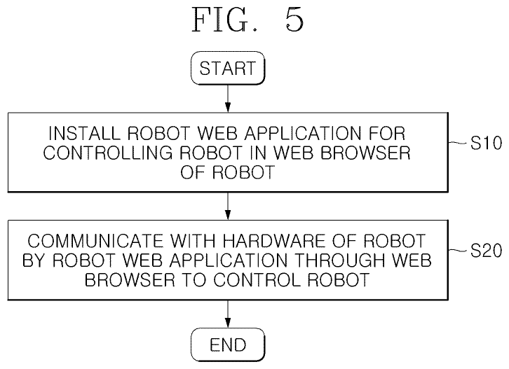

FIG. 5 is a flowchart illustrating a web browser-based robot control method according to an embodiment of the present invention. Here, respective steps in FIG. 5 may be performed by the robot 100 according to an embodiment of the present invention.

Referring to FIG. 5, the robot 100 may be installed with the robot web application 110 for controlling the robot in the web browser 120 of the robot (S10). The robot web application 110 is a set of software for controlling the operation of the robot 100, and may be operated on the web browser 120. Here, the web browser 120 may be produced based on the Chromium Operating System, the Chrome Operating System, the Whale Operating System, Ubuntu, Debian, or the like, and various web applications such as the robot web application 110 may be executed on the web browser 120.

According to one embodiment, the web browser 120 may be a dedicated web browser customized such that the robot web application 110 is able to control the hardware of the robot 100. That is, the web browser 120 may define a robot control API for controlling the hardware of the robot 100 and perform communication with the hardware of the robot 100 using the robot control API. In the case of a general web browser, the range of access to the hardware of the robot 100 is limited, so the dedicated web browser 120 that defines additional robot control APIs may be utilized here.

The robot control API may include motor control of the robot 100 such as motor speed, position, and torque, setting of a movement path plan such as waypoints, setting of a goal point, acquisition of various sensor values, voice commands, etc., and may be configured in various ways from low-level motor control to high-level abstract commands. However, it is not limited thereto, and various types of robot control APIs may be further included depending on the embodiment.

Additionally, depending on the embodiment, it is also possible to utilize a general web browser instead of the dedicated web browser. In this case, a proxy application may be further included in the web browser 120, and the proxy application may communicate with the hardware of the robot 100 using the robot control API.

The robot 100 may receive the robot web application 110 from the external server 200 and install the same, and the server 200 may provide management such as addition, deletion, change, and update for the robot web application 110.

Thereafter, the robot web application 110 may communicate with the hardware of the robot 100 through the web browser 120, thereby controlling the robot 100 (S20).

Here, the web browser 120 may directly communicate with the hardware of the robot 100 using the robot control API. For example, the web browser 120 may perform direct control of the hardware of the robot 100 using a low-level robot control API.

In addition, depending on the embodiment, it is also possible to perform communication with the hardware of the robot 100 through robot middleware such as ROS or ROS2. That is, the web browser 120 may perform communication with the middleware provided between the hardware of the robot and the same using the robot control API, and then perform communication with the hardware of the robot 100 through the middleware.

In addition, depending on the embodiment, it is also possible to implement the web browser 120 to directly communicate with the hardware of the robot 100 or to communicate with the hardware of the robot 100 using middleware, depending on the type of control command.

The robot web application 110 may receive control commands from the external server 200 through a network, thereby controlling the operation of the robot 100.

The present disclosure described above may be implemented as a computer-readable code on a medium on which a program is recorded. The computer-readable medium may be a medium that continuously stores a computer-executable program or temporarily stores it for execution or download. In addition, the medium may be a variety of recording means or storage means in the form of a single piece of hardware or a combination of multiple pieces of hardware, and may not be limited to a medium directly connected to a computer system, but may also be distributed on a network. Examples of the medium may include magnetic media such as hard disks, floppy disks, and magnetic tapes, optical recording media such as CD-ROMs and DVDs, magneto-optical media such as floptical disks, ROMs, RAMs, flash memories, and the like, which are configured to store program instructions. In addition, examples of other media may include recording media or storage media managed by app stores that distribute applications, or sites or servers that supply or distribute various software.

The above detailed description should not be construed as limiting the present disclosure in all respects and should be considered as examples. The scope of the present invention should be determined by a reasonable interpretation of the appended claims, and all changes within the equivalent scope of the present invention are included in the scope of the present invention.

The present invention is not limited to the above-described embodiments and the attached drawings. It will be apparent to those skilled in the art to which the present invention pertains that components according to the present invention can be substituted, modified, and changed within a scope that does not depart from the technical idea of the present invention.

What is claimed is:

1. A robot control method based on a web browser, comprising:
installing a robot web application for controlling a robot in a web browser of the robot; and
controlling the robot by having the robot web application communicate with hardware of the robot through the web browser.

2. The robot control method of claim 1, wherein the web browser is produced based on one of a Chromium Operating System, a Chrome Operating System, a Whale Operating System, a Ubuntu Operating System, and a Debian Operating System.

3. The robot control method of claim 2, wherein the web browser is configured to define a robot control Application Programming Interface (API) for controlling the hardware of the robot, and perform communication with the hardware of the robot using the robot control API.

4. The robot control method of claim 3, wherein the robot control API controls at least one of motor control of the robot, setting of a movement path plan, setting of a goal point, acquisition of sensor values, and voice commands.

5. The robot control method of claim 3, wherein, in the controlling of the robot, the web browser performs direct communication with the hardware of the robot using the robot control API.

6. The robot control method of claim 3, wherein, in the controlling of the robot, the web browser performs communication with middleware provided between the hardware of the robot and the web browser using the robot control API, and performs communication with the hardware of the robot through the middleware.

7. The robot control method of claim 1, wherein the web browser further comprises:
a proxy application, and
the proxy application performs communication with the hardware of the robot using the robot control API.

8. The robot control method of claim 1, wherein the installing of the robot web application comprises:
receiving the robot web application from an external server and installing the robot web application.

9. The robot control method of claim 8, wherein, in the controlling of the robot, the robot web application controls the robot according to a control command received from the external server.

10. A non-transitory computer-readable recording media storing a computer program which, when executed by a processor, controls the processor to perform the robot control method according to claim 1.

11. A robot, comprising:
processor,
wherein the processor is configured to:
install a robot web application for controlling the robot in a web browser of the robot; and
control the robot by having the robot web application communicate with hardware of the robot through the web browser.
